(19) United States
(12) Patent Application Publication
(10) Pub. No.: US 2010/0095986 A1
(43) Pub. Date: Apr. 22, 2010

(54) METHOD OF CLEANING MICRO-FLOW PASSAGES

(75) Inventors: Yoshihiro Seto, Ashigarakami-gum (JP); Luc Bousse, Mountain View, CA (US); Chen Li, Mountain View, CA (US)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, TOKYO (JP)

(21) Appl. No.: 12/593,860

(22) PCT Filed: Mar. 28, 2008
(86) PCT No.: PCT/US08/58624

§ 371 Date: Sep. 29, 2009

Related U.S. Application Data
(60) Provisional application No. 60/920,832, filed on Mar. 30, 2007.

(51) Int. Cl. B08B 9/032; B08B 9/035

(52) U.S. Cl. 134/22.12; 134/22.11

(57) ABSTRACT

To improve cleansing quality of wall surfaces of micro-flow channels in a micro-flow channel cleansing method. During cleansing of wall surfaces of micro-flow channels having at least one branching channel, by causing cleansing fluid to flow therethrough, the cleansing fluid is caused to flow through the at least one branching channel such that there is no residual fluid on the wall surfaces thereof.

### CROSS-REFERENCE TO RELATED APPLICATION

This application claims priority to U.S. Provisional Application Ser. No. 60/920,832, filed on Mar. 30, 2007.

### TECHNICAL FIELD

The present invention relates to a micro-flow channel cleansing method. More specifically, the present invention relates to a micro-flow channel cleansing method for cleansing micro-flow channels provided with branching channels.

### BACKGROUND ART

Electrophoresis apparatuses and chemical processing apparatuses that utilize micro-flow channel substrates, in which extremely fine micro-flow channels (for example, 100 μm wide and 15 μm deep) are formed between stacked glass plates, are known (Patent Document 1).

The electrophoresis apparatuses introduce sample liquids containing reagents, samples, buffer liquid and the like into the micro-flow channels. The electrophoresis apparatuses apply high voltage (electrophoretic voltage) to the introduced sample liquids to cause electrophoresis to occur. Measurement target substances within the samples, such as proteins and nucleic acids, are separated by electrophoresis and detected at detection points within the micro-flow channels.

The chemical processing apparatuses introduce various liquids into the micro-flow channels as raw materials, administer chemical processes, and generate fine particles.

In the aforementioned apparatuses, micro-flow channel substrates, in which the micro-flow channels are formed, are repeatedly utilized for measurement. Accordingly, techniques for reusing the micro-flow channel substrates are known. In these techniques, cleansing fluid is caused to flow through the micro-flow channels to cleanse the micro-flow channels after detection of the measurement target substances or the generation of the fine particles is completed.

### [Patent Document 1]

Japanese Unexamined Patent Publication No. 2004-243308

Micro-flow channels which are formed in elongate glass tubes are linear channels that extend unidirectionally. However, among micro-flow channels formed in micro-flow channel substrates, there are those that have two dimensional structures composed of branching channels. When cleansing fluid is caused to flow through these micro-flow channels which are provided with branching channels, there are cases in which residual fluids remain on the wall surfaces of the branching channels. In these cases, the cleansing fluid remains on specific wall surfaces within the branching channels. That is, foreign substances remain on the specific wall surfaces, even after cleansing.

Foreign substances remaining on wall surfaces after cleansing is a problem which is not limited to cleansing of micro-flow channels of micro-flow channel substrates which are utilized by the aforementioned electrophoresis apparatuses and chemical processing apparatuses. This is a common problem which is encountered when cleansing micro-flow channels provided with branching channels.

The present invention has been developed in view of the foregoing circumstances. It is an object of the present invention to provide a cleansing method for micro-flow channels that can improve the quality of cleansing of micro-flow channels.

### DISCLOSURE OF THE INVENTION

A micro-flow channel cleansing method of the present invention is a micro-flow channel cleansing method for cleansing wall surfaces of micro-flow channels having at least one branching channel, by causing cleansing fluid to flow therethrough, characterized by:

the cleansing fluid being caused to flow through the at least one branching channel such that there is no residual fluid on the wall surfaces thereof.

In the micro-flow channel cleansing method of the present invention, the wall surfaces of the at least one branching channel may be cleansed, by changing the flow direction of the cleansing fluid with respect to the at least one branching channel. The change in the flow direction of the cleansing fluid may be realized by performing injection and suction of the cleansing fluid into and out of a single micro-flow channel that communicates with the at least one branching channel.

In the micro-flow channel cleansing method of the present invention, the wall surfaces of the at least one branching channel may be cleansed, by changing the flow direction of the cleansing fluid with respect to the at least one branching channel. The change in the flow direction of the cleansing fluid may be realized by performing injection and suction of the cleansing fluid into and out of different micro-flow channels that have the at least one branching channel therebetween and communicate therewith, at least once.

The at least one branching channel may branch in a T-shape.

The micro-flow channels may be formed in a microchip to be utilized by a clinical analysis apparatus, and may be for reagents and samples to be introduced thereinto.

Note that the phrase “the cleansing fluid being caused to flow through the at least one branching channel such that there is no residual fluid on the wall surfaces thereof” means that the cleansing fluid is caused to flow through the at least one branching channel such that the cleansing fluid flows across the entirety of the wall surfaces thereof.

According to the micro-flow channel cleansing method of the present invention, the cleansing fluid is caused to flow through the at least one branching channel such that there is no residual fluid on the wall surfaces thereof. Therefore, the quality of cleansing of micro-flow channels can be improved.

That is, the cleansing fluid is caused to flow through the at least one branching channel such that the cleansing fluid flows across the entirety of the wall surfaces thereof such that no residual fluid remains on the wall surfaces of the at least one branching channel. Thereby, sample liquids, the cleansing fluid and the like are prevented from remaining on specific wall surfaces that constitute the at least one branching channel. Foreign substances which are adhered to the wall surfaces of branching channels can be dissolved in the cleansing fluid, or removed by the force applied thereon by the cleansing fluid. Accordingly, the foreign substances are positively removed from the wall surfaces, and the quality of cleansing of the micro-flow channels can be improved.

The flow direction of the cleansing fluid with respect to the at least one branching channel may be changed, by performing injection and suction of the cleansing fluid into and out of a single micro-flow channel that communicates with the at least one branching channel. In this case, the cleansing fluid can be caused to flow through all of the wall surfaces of the at least one branching channel more positively, further improving the quality of cleansing of the micro-flow channels.

The flow direction of the cleansing fluid with respect to the at least one branching channel may be changed, by performing injection and suction of the cleansing fluid into and out of different micro-flow channels that have the at least one branching channel therebetween and communicate therewith, at least once. In this case, the cleansing fluid can be caused to flow through all of the wall surfaces of the at least one branching channel more positively, further improving the quality of cleansing of the micro-flow channels.

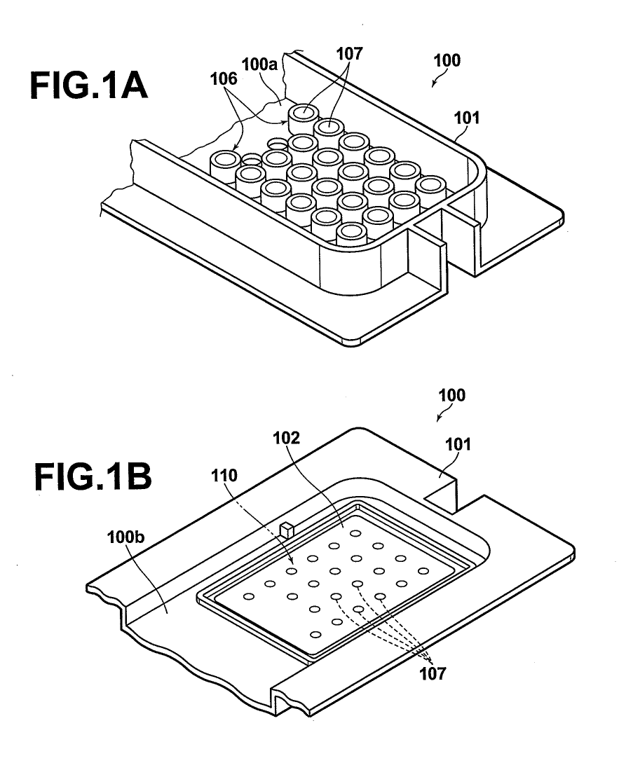

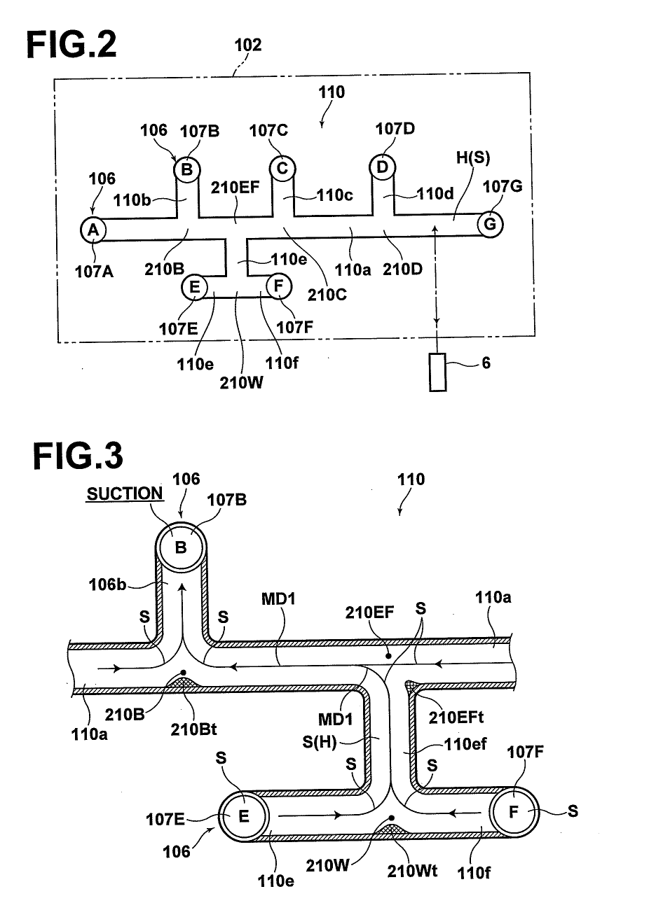

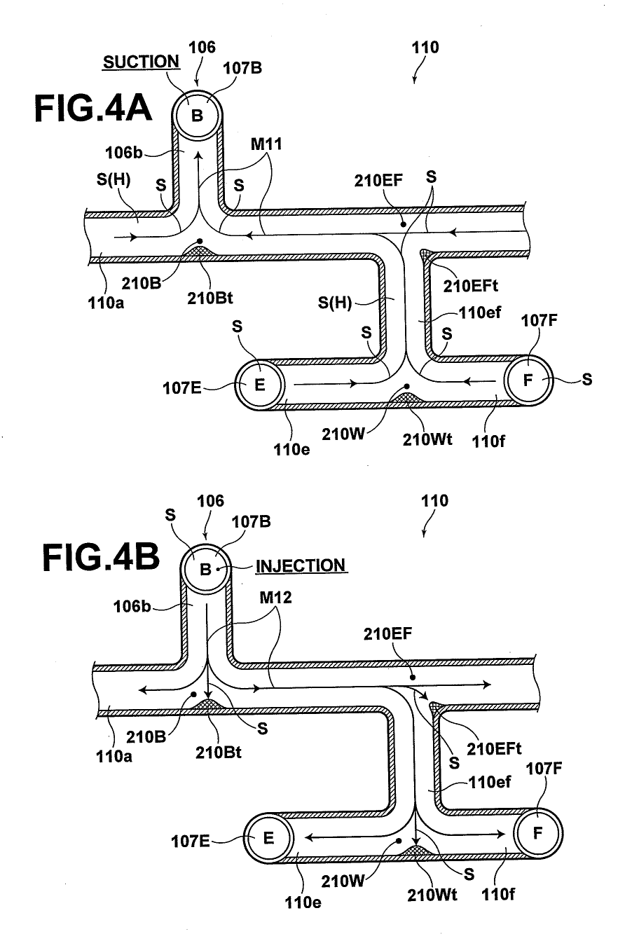

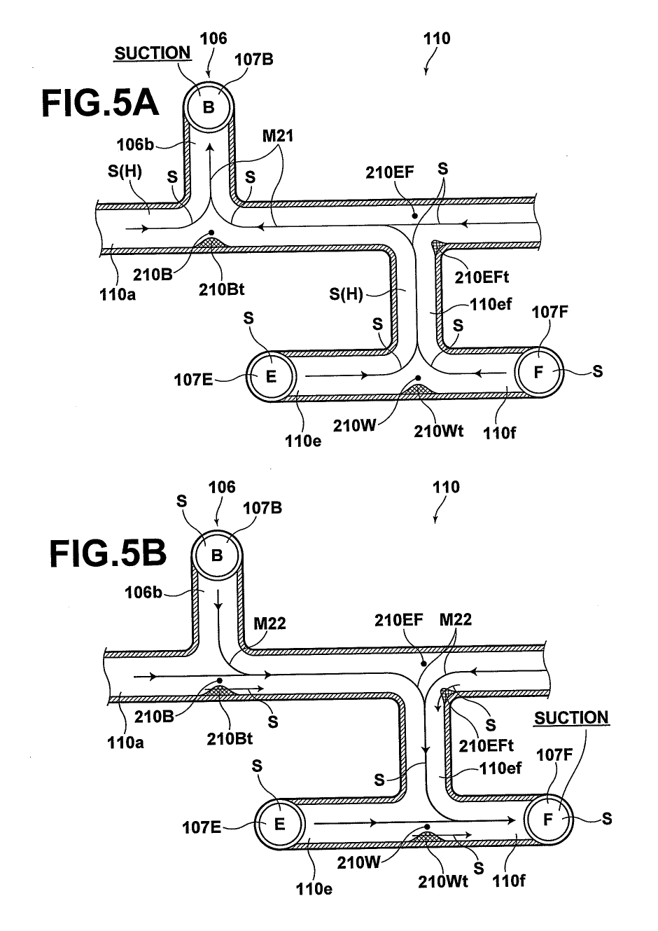

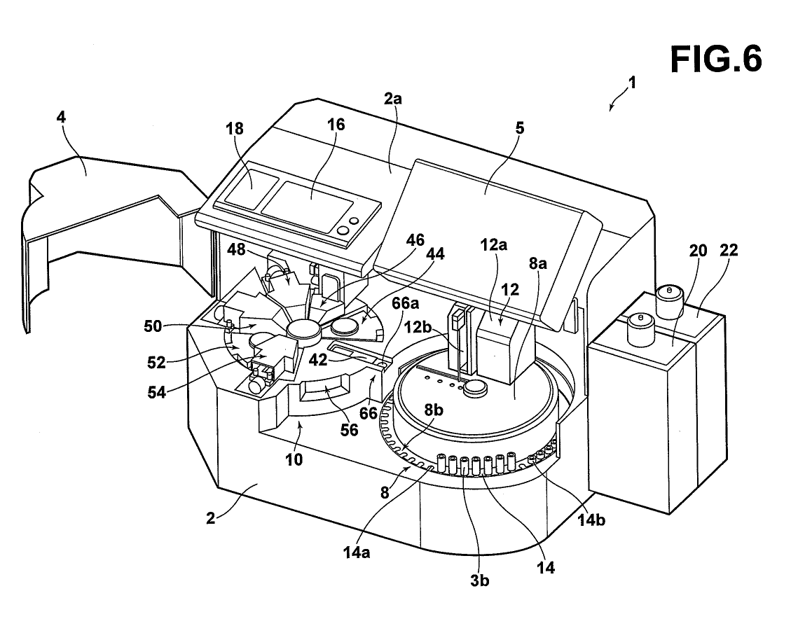

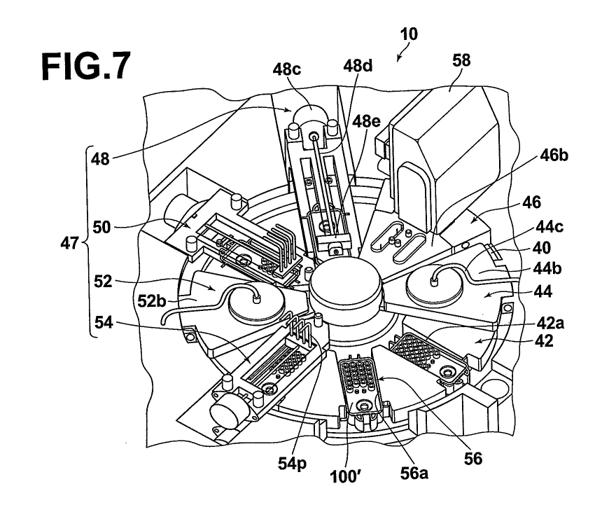

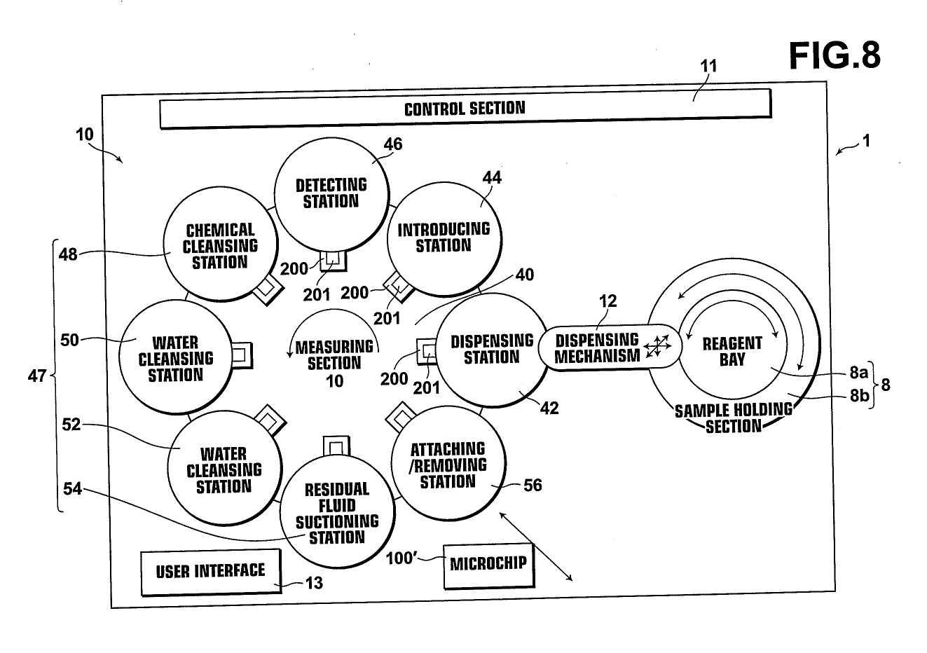

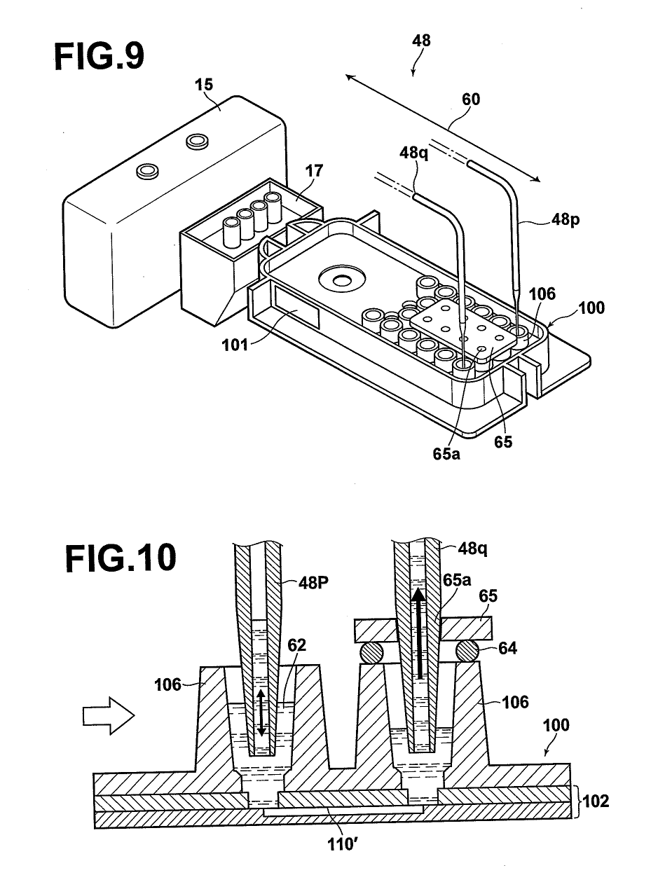

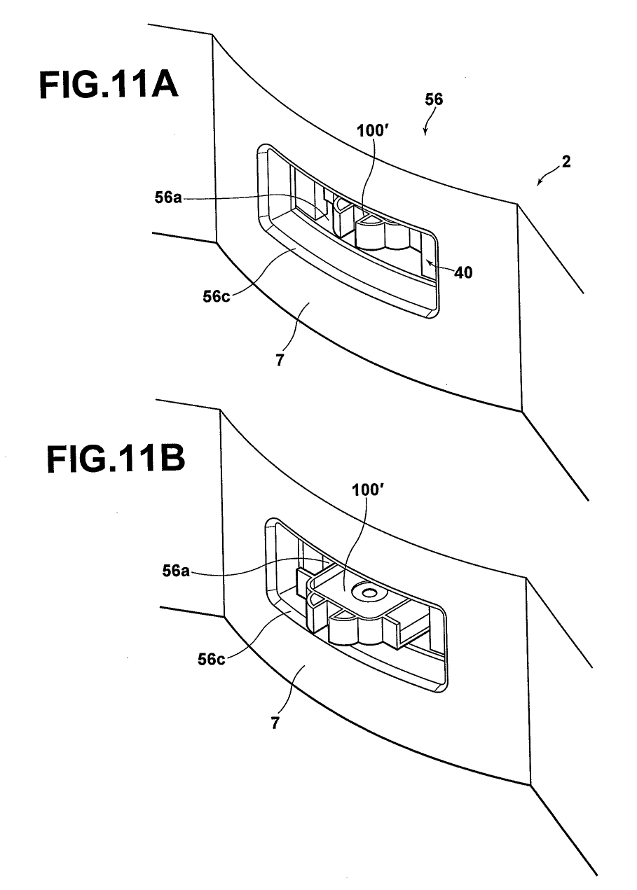

### BRIEF DESCRIPTION OF THE DRAWINGS

[FIG. 1] a diagram that illustrates an example of a microchip having micro-flow channels, to which the micro-flow channel cleansing method of the present invention is applied; FIG. 1A is a perspective view of the microchip viewed from the top surface thereof, and FIG. 1B is a perspective view of the microchip viewed from the bottom surface thereof

[FIG. 2] a plan view that illustrates an example of micro-flow channels which are formed in the microchip

[FIG. 3] a diagram that illustrates a comparative example of a cleansing method for micro-flow channels

[FIG. 4] a diagram that illustrates how micro-flow channels are cleansed by a first embodiment of the micro-flow channel cleansing method; FIG. 4A illustrates a state in which cleansing fluid is suctioned into a sub flow channel, and FIG. 4B illustrates a state in which cleansing fluid is injected into the sub flow channel

[FIG. 5] a diagram that illustrates how micro-flow channels are cleansed by a second embodiment of the micro-flow channel cleansing method; FIG. 5A illustrates a state in which cleansing fluid is suctioned through a sub flow channel, and FIG. 5B illustrates a state in which cleansing fluid is suctioned through a sub flow channel different from the aforementioned sub flow channel

[FIG. 6] a perspective view that illustrates the outer appearance of a clinical analysis apparatus of the present invention

[FIG. 7] a magnified perspective view of a measuring section of the clinical analysis apparatus of FIG. 6, in a state in which microchips 100 are provided therein

[FIG. 8] a schematic view that illustrates a stocking section and a measuring section as the main parts of the clinical analysis apparatus

[FIG. 9] a magnified perspective view that illustrates the main parts of a chemical cleansing station of the clinical analysis apparatus

[FIG. 10] a magnified sectional view that illustrates a state in which a well is cleansed, and a state in which negative pressure is applied on a well

[FIG. 11] magnified perspective views of the manner in which microchips are exchanged at a attaching/removing station of the clinical analysis apparatus; FIG. 11A illustrates a state in which a microchip is standing by at the attaching/removing station, and FIG. 11B illustrates a state in which a microchip is being discharged from the attaching/removing station

### BEST MODE FOR CARRYING OUT THE INVENTION

Hereinafter, the micro-flow channel cleansing method of the present invention will be described in detail. FIG. 1 is a diagram that illustrates an example of a microchip having micro-flow channels, to which the micro-flow channel cleansing method of the present invention is applied. FIG. 1A is a perspective view of the microchip viewed from the top surface thereof, and FIG. 1B is a perspective view of the microchip viewed from the bottom surface thereof. FIG. 2 is a plan view that illustrates an example of micro-flow channels which are formed in the microchip.

The microchip 100 illustrated in FIG. 1, to which the micro-flow channel cleansing method of the present invention is applied, is utilized by a clinical analysis apparatus (for example, that which detects liver cancer markers). The microchip 100 is provided with at least one branching channel that branches a flow channel.

The microchip 100 is constituted by: a cover 101 formed by synthetic resin or the like; and a micro-flow channel substrate 102 formed by a substantially rectangular glass plate (a transparent plate member), for example, provided at the central portion of a recess 100b on the bottom surface of the cover 101.

The micro-flow channel substrate 102 is constituted by two glass plates (refer to FIG. 10). The two glass plates are laminated together into a single substrate so as to sandwich micro-flow channels 110 (also referred to as capillaries; hereinafter, simply referred to as flow channels 110) therebetween. Both of the glass plates may be transparent. Alternatively, only one of them, through which light is transmitted when optical measurement (to be described later) is performed, may be transparent.

A plurality of cylindrical protrusions, that is, wells 106, having inner diameters of 1.2 mm for example, are formed on the top surface, that is, the main surface 100a of the microchip 100. The positions of the wells 106 are matched to the flow channels 110 formed in the micro-flow channel substrate 102. Well apertures 107, which are apertures provided within the wells 106, penetrate through one of the glass plates to communicate with the flow channels 110.

Accordingly, if sample fluids containing reagents and samples are dripped into the wells 106, the sample fluids are introduced into the flow channels 110. Note that the micro-flow channel substrate 102 may be formed by a synthetic resin, instead of glass.

Next, the flow channels will be described with reference to FIG. 2. FIG. 2 is a plan view that illustrates an example of flow channels 110 which are formed in the micro-flow channel substrate 102. The flow paths 110 are 100 μm wide and 15 μm deep, for example. The flow channels 110 are formed by a micro processing technique, such as etching or photolithography. Note that two or more sets of independent flow channels may be formed in the microchip 100.

The flow channels 110 are constituted by: a main flow channel 110a that extends linearly in the horizontal direction of FIG. 2, shorter sub flow channels 110b through 110f that branch from the main flow channel 110a at right angles and extends for short distances, and a flow channel ef. The aforementioned well apertures 107 are positioned at the ends of the main flow channel 110a, the sub flow channels 110b through 110f, and the sub flow channel ef. Note that these well apertures 107 will be discriminated as well apertures 107A through 107G. The well apertures 107A through 107G will be collectively referred to as “well apertures 107”.

The left end (toward the left in FIG. 2) of the main flow channel 110a is in communication with the well aperture 107A, and the right end (toward the right in FIG. 2) of the main flow channel 110a is in communication with the well aperture 107G.

The sub flow channels 110b, 110c, and 110d are flow channels that branch off from the main flow channel 110a at branching points 210B, 210C, and 210D, respectively. The sub flow channels 110b, 110c, and 110d branch off from the main flow channel 110a toward a first side thereof (the upper side in FIG. 2), in an inverted T shape. The sub flow channels 110b, 110c, and 110d are formed along the main flow channel 110a from the side of the well aperture 107a with intervals therebetween. Each of the ends of the sub flow channels 110b, 110c, and 110d are in communication with the well apertures 107B, 107C, and 107D, respectively.

The sub flow channel 110ef is a flow channel that branches off from the main flow channel 110a at a branching point 210EF. The sub flow channel 110ef branches off from the main flow channel 110a toward a second side thereof (the lower side in FIG. 2), in a T shape. The sub flow channel 110ef is formed between the sub flow channels 110b and 110c. A branching point 210W is provided at the leading end of the sub flow channel 110ef. Sub flow channels 110e and 110f are formed to extend parallel to the main flow channel 110a with the branching point 210W therebetween. The ends of the sub flow channels 110e and 110f are in communication with the well apertures 107E and 107F, respectively.

Note that the branching points 210B, 210C, 210D, 210EF, and 210W are collectively referred to as “branching points 210”.

As illustrated in FIG. 2, a measurement target substance within the sample included in the sample fluid H that flows in the flow channels 110 is detected by a detecting device having an optical system.

The measurement target substance included in the sample fluid H within the flow channels 110 is processed to emit fluorescence when excited by external light. The measurement target substance within the sample fluid H can be detected by detecting the fluorescence.

Here, cleansing of the micro-flow channels 110 formed in the micro-flow channel substrate 102 will be described. Note that the micro-flow channel cleansing method of the present invention which is employed to cleanse the micro-flow channels 110 may be applied to the cleansing of micro-flow channels at a cleansing station of a clinical analysis apparatus, to be described later.

### Comparative Example

First, a comparative example of a cleansing operation for the micro-flow channels 110 of the micro-flow channel substrate 102 will be described with reference to FIG. 2 and FIG. 3. In this comparative example, residual fluids remain on the wall surfaces of the branching channels when the micro-flow channels 110 are cleansed, and the quality of cleansing is not high. FIG. 3 is a magnified plan view of a portion of the micro-flow channels 110 which are formed in the micro-flow channel substrate 102.

The well apertures 107, which are in communication with the micro-flow channels 110 that contain the sample fluid H, excluding the well aperture 107B, that is, the well apertures 107A and 107C through 107G, are filled with cleansing fluid S.

Then, the well aperture 107B is employed as a suction opening. The sample fluid H within the micro-flow channels 110 and the cleansing fluid S within the well apertures 107A and 107C through 107G are suctioned through the well aperture 107B.

As illustrated in FIG. 3, the suction from the well aperture 107B causes the liquids within the micro-flow channels 110 to flow along fluid trajectories MO1. The wall surfaces of the micro-flow channels 110 are cleansed by the cleansing fluid that flows along the fluid trajectories MO1. However, the cleansing fluid S that approaches branching points from both directions flows in directions away from the wall surfaces 210Bt, 210EFt, and 210Wt at branching points 210B, 210EF, and 210W, respectively. Therefore, almost none of the sample fluid H at the wall surfaces 210Bt, 210EFt, and 210Wt flows away from the wall surfaces, thereby causing residual fluid to remain thereon.

That is, the cleansing fluid S that flows into the branching point 210B from both sides of the wall surface 210Bt flows through the flow channel 110b toward the well aperture 107B from the branching point 210B. However, because residual fluid remains on the wall surface 210Bt, foreign substances on the wall surface 210Bt (contaminants and the like which are attached on the wall surface 210Bt) are not dissolved or removed therefrom, or only a small portion of the foreign substances are dissolved or removed. Accordingly, the foreign substances remain on the wall surface 210Bt.

Similarly, the cleansing fluid S that flows into the branching point 210EF from the flow channels 110a and 110ef on either side of the wall surface 210EFt flows through the flow channel 110a toward the branching point 210B. However, because residual fluid remains on the wall surface 210EFt, foreign substances on the wall surface 210EFt (contaminants and the like which are attached on the wall surface 210EFt) are not dissolved or removed therefrom, or only a small portion of the foreign substances are dissolved or removed. Accordingly, the foreign substances remain on the wall surface 210EFt.

Further, the cleansing fluid S that flows from the well apertures 107E and 107F toward the branching point 210W from the flow channels 110e and 110f on either side of the wall surface 210Wt flows through the flow channel 110ef toward the branching point 210EF. However, because residual fluid remains on the wall surface 210Wt, foreign substances on the wall surface 210Wt (contaminants and the like which are attached on the wall surface 210Wt) are not dissolved or removed therefrom, or only a small portion of the foreign substances are dissolved or removed. Therefore, the foreign substances remain on the wall surface 210Bt.

Accordingly, it is not possible to remove contaminants and the like which are attached to the wall surfaces 210Bt, 210EFt, and 210Wt.

### First Embodiment

Hereinafter, a first embodiment of the micro-flow channel cleansing method of the present invention, which cleanses the micro channels 110 of the micro-flow channel substrate 102 such that no residual fluid remains on the wall surfaces of the branching channels, will be described with reference to FIG. 2, FIG. 4A, and FIG. 4B. FIG. 4A and FIG. 4B are magnified plan views of a portion of the micro-flow channels 110 which are formed in the micro-flow channel substrate 102. FIG. 4A illustrates a state in which cleansing fluid is suctioned into a sub flow channel, and FIG. 4B illustrates a state in which cleansing fluid is injected into the sub flow channel.

Note that the micro-flow channel cleansing method of the present invention is the same as the comparative example, which is not capable of obtaining high cleansing quality, up to a point.

In a manner similar to that of the comparative example, the well apertures 107, which are in communication with the micro-flow channels 110 that contain the sample fluid H, excluding the well aperture 107B, that is, the well apertures 107A and 107C through 107G, are filled with cleansing fluid S.

Then, the well aperture 107B is employed as a suction opening. The sample fluid H within the micro-flow channels 110 and the cleansing fluid S within the well apertures 107A and 107C through 107G are suctioned through the well aperture 107B. That is, the sample fluid H and the cleansing fluid S are suctioned through a single flow channel 110b, which is in communication with the branching points 210B, 210W, etc. within the micro-flow channels 110.

In a manner similar to that of the comparative example (as illustrated in FIG. 4A), the suction from the well aperture 107B causes the liquids within the micro-flow channels 110 to flow along fluid trajectories M11. The fluid trajectories Mil are the same as the fluid trajectories M01 of the comparative example. Therefore, almost none of the sample fluid H at the wall surfaces 210Bt, 210EFt, and 210Wt flows away from the wall surfaces, thereby causing residual fluid to remain thereon. Accordingly, it is not possible to remove contaminants which are attached to the wall surfaces 210Bt, 210EF1, and 210W1 with the steps of the method up to this point.

Next, as illustrated in FIG. 4B, the well aperture 107B is employed as an injection opening for the cleansing fluid S, and the cleansing fluid S is injected through the well aperture 107B into the flow channel 110b and the other micro-flow channels via the branching point 210B. That is, the cleansing fluid S is injected into the flow channel 110b, which is in communication with the branching points 210B, 210W, etc. within the micro-flow channels.

The injection of the cleansing fluid S causes the cleansing fluid S to flow through the micro-flow channels along fluid trajectories M12. That is, the direction of flow of the fluid that passes through the micro-flow channel is reversed from the case in which the cleansing fluid S is suctioned. Thereby, the wall surfaces 210Bt, 210EFt, and 210Wt, at which the sample fluid H had remained, become in a state in which they are showered with the cleansing fluid S (a state in which the cleansing fluid S flows thereon). Accordingly, cleansing effects, such as the foreign substances attached to the wall surfaces (contaminants and the like which are attached to the wall surfaces) being dissolved or physically removed, are obtained, and the foreign substances can be removed from the wall surfaces.

Therefore, the wall surfaces 210Bt, 210EFt, and 210Wt can be cleansed in a manner similar to that in which other wall surfaces are cleansed. That is, the foreign substances can be removed from the wall surfaces 210Bt, 210EFt, and 210Wt.

The first embodiment changes the direction in which the cleansing fluid S is caused to flow through the branching points 210B, 210EF, and 210W, by performing injection of the cleansing fluid S into a specific flow channel 110b, which is in communication with the branching points 210B, 210EF, and 210W within the micro-flow channels 110, and suction of the cleansing fluid S from the specific flow channel 110b. The quality of cleansing of the wall surfaces of the branching points can be improved, by changing the direction in which the cleansing fluid S is caused to flow with respect to the branching points.

Note that the micro-flow channels are not limited to being cleansed by performing suction and injection through a single flow channel. Suction may be performed simultaneously through two or more specific flow channels, then injection may be performed simultaneously through the two or more specific flow channels, to cleanse the micro-flow channels 110.

### Second Embodiment

Next, a second embodiment of the micro-flow channel cleansing method of the present invention will be described with reference to FIG. 5A and FIG. 5B. FIG. 5A and FIG. 5B are magnified plan views of a portion of the micro-flow channels 110 which are formed in the micro-flow channel substrate 102. FIG. 5A illustrates a state in which cleansing fluid is suctioned through the well aperture 107B, and FIG. 5B illustrates a state in which cleansing fluid is suctioned through the well aperture 107F.

In a manner similar to that of the first embodiment, the well apertures 107, which are in communication with the micro-flow channels 110 that contain the sample fluid H, excluding the well aperture 107B, that is, the well apertures 107A and 107C through 107G, are filled with cleansing fluid S. Then, the well aperture 107B is employed as a suction opening. The sample fluid H within the micro-flow channels 110 and the cleansing fluid S within the well apertures 107A and 107C through 107G are suctioned through the well aperture 107B. The suction from the well aperture 107B causes the liquids within the micro-flow channels 110 to flow along fluid trajectories M21. The fluid trajectories M21 are the same as the fluid trajectories M01 of the comparative example and the fluid trajectories M11 of the first embodiment. Therefore, almost none of the sample fluid H at the wall surfaces 210Bt, 210EFt, and 210Wt flows away from the wall surfaces, thereby causing residual fluid to remain thereon. Accordingly, it is not possible to remove contaminants which are attached to the wall surfaces 210Bt, 210EF1, and 210W1 with the steps of the method up to this point.

Next, as illustrated in FIG. 5B, the suction opening is changed to the well aperture 107F. The well apertures 107 excluding the well aperture 107F, that is, the well apertures 107A through 107E and 107G, are filled with cleansing fluid S, and the cleansing fluid S is suctioned through the well aperture 107F.

The suction of the cleansing fluid S through the well aperture 107F causes the cleansing fluid S to flow through the micro-flow channels along fluid trajectories M22. Thereby, the wall surfaces 210Bt, 210EFt, and 210Wt, at which the sample fluid H had remained, become in a state in which the cleansing fluid S flows thereon. Accordingly, cleansing effects, such as the foreign substances attached to the wall surfaces (contaminants and the like which are attached to the wall surfaces) being dissolved or physically removed (pushed away by the flow), are obtained, and the foreign substances can be removed from the wall surfaces.

Therefore, the wall surfaces 210Bt, 210EFt, and 210Wt can be cleansed in a manner similar to that in which other wall surfaces are cleansed. That is, the foreign substances can be removed from the wall surfaces 210Bt, 210EFt, and 210Wt.

The second embodiment changes the direction in which the cleansing fluid S is caused to flow through the branching points 210B, 210EF, and 210W, by performing injection or suction of the cleansing fluid S through each of two specific flow channels 110b and 110f, which are in communication with the branching points 210B, 210EF, and 210W within the micro-flow channels 110. The quality of cleansing of the wall surfaces of the branching points can be improved, by changing the direction in which the cleansing fluid S is caused to flow with respect to the branching points.

The micro-flow channels are not limited to being cleansed by performing suction of cleansing fluid through a first flow channel of two different flow channels that have the branching channels therebetween and communicate therewith, then performing suction of the cleansing fluid through a second flow channel, to change the direction in which the cleansing fluid flows with respect to the branching channels. Alternatively, the cleansing fluid may be suctioned through the first flow channel of the two different flow channels that have the branching channels therebetween and communicate therewith, and then the cleansing fluid may be injected from the second flow channel, in order to change the direction in which the cleansing fluid flows with respect to the branching channels during cleansing thereof.

As another alternative, the cleansing fluid may be injected into the first flow channel of the two different flow channels that have the branching channels therebetween and communicate therewith, and then the cleansing fluid may be suctioned through the second flow channel, in order to change the direction in which the cleansing fluid flows with respect to the branching channels during cleansing thereof.

As a further alternative, the cleansing fluid may be injected into the first flow channel of the two different flow channels that have the branching channels therebetween and communicate therewith, and then the cleansing fluid may be injected into the second flow channel, in order to change the direction in which the cleansing fluid flows with respect to the branching channels during cleansing thereof.

Note that the micro-flow channels are not limited to being cleansed by performing injection into a single flow channel. Injection may be performed into two or more flow channels. In addition, the micro-flow channels are not limited to being cleansed by performing suction from a single flow channel. Suction may be performed from two or more flow channels.

In the embodiments described above, the branching points are those that branch in T shapes. However, the branching points are not limited to those that branch in T shapes. The micro-flow channel cleansing method of the present invention may be applied to branching points that branch in any shape, such as a Y shape.

### <Clinical Analysis Apparatus>

Hereinafter, an example of a clinical analysis apparatus that utilizes the micro-flow channel cleansing method of the present invention will be described. That is, a case in which the micro-flow channels are formed in a microchip to be utilized in the clinical analysis apparatus, and reagents and samples are introduced thereinto, will be described with reference to FIG. 6 through FIG. 11. FIG. 6 is a perspective view that illustrates the outer appearance of the clinical analysis apparatus.

As illustrated in FIG. 6, the apparatus 1 is constituted by: a casing 2; a stocking section 8, provided in the casing 2; a measuring section 10 provided in the vicinity of the stocking section 8; and a dispensing mechanism 12 that moves reciprocally between the stocking section 8 and the measuring section 10. Covers 4 and 5, which are openable and closable with respect to the casing 2, are provided to cover the measuring section 10 and the stocking section 8, respectively. The covers 4 and 5 are configured such that they cannot be opened during detection of samples and cleansing operations. The stocking section 8 includes a circular reagent bay 8a and a sample holding section 8b. The sample holding section 8b includes an annular member 14 that surrounds the periphery of the reagent bay 8a. Note that the reagent bay 8a and the sample holding section 8b are rotatable. However, drive sources such as motors for rotating the reagent bay 8a and the sample holding section 8b have been omitted from FIG. 3. A plurality of cutouts 14a for holding sample containers 3b are formed in the annular member 14 at predetermined intervals. Note that the interior of the stocking section 8 is cooled by a cooling device (not shown).

A display panel 16 constituted by an LCD or the like is provided on the upper surface 2a of the casing 2. The display panel 16 displays the names of tests, and enables selection of the contents of measurement (items to be measured) for each sample. A printer 18 for printing out detection results obtained by a detecting station 46 is provided in the vicinity of the display panel 16. A parallelepiped cleansing water container 20 and a parallelepiped waste liquid container 22 are mounted on the exterior of the casing 2 in the vicinity of the stocking section 8. The cleansing water container 20 contains water for cleansing the microchips 100 and the like. The waste liquid container 22 contains all waste liquids.

The dispensing mechanism 12 includes: a moving body 12a; and a probe 12b, which is attached to the moving body 12a.

Next, the measuring section 10 will be described with combined reference to FIG. 6 and FIGS. 7 through 11. FIG. 7 is a magnified perspective view of the measuring section 10, in which microchips 100 are provided. FIG. 8 is a schematic plan view that illustrates the stocking section 8 and the measuring section 10 as the main parts of the apparatus 1.

The measuring 10 is equipped with: a drive source (not shown) that functions as a conveyance mechanism for conveying the microchips 100; and a rotating table 40 which is driven to rotate counterclockwise by the drive source. The rotating direction of the rotating 40 is unidirectional in the counterclockwise direction, and the drive source is not configured to enable clockwise rotation.

Eight bases are provided on the rotating table 40 at a predetermined pitch. A microchip 100 is to be placed on each of the bases. When the rotating table 40 is viewed from above as illustrated in FIG. 7, eight recesses 42a are formed at the predetermined pitch (angular pitch), and the bases are housed within the recesses 42a. Accordingly, when the microchips 100 are placed within the recesses 42a, the microchips 100 are placed on the bases which are provided corresponding to the recesses 42a.

Eight stations 42, 44, 46, 48, 50, 52, 54, and 56 are provided in the casing 2 at the same predetermined pitch (angular pitch). Accordingly, a microchip 100 is to be placed at positions corresponding to each of the stations 42 through 56.

The first station, at which the measurement operation is initiated, is a dispensing station 42, at which samples and the like are dispensed into the microchips 100 by the probe 12b of the dispensing mechanism 12. That is, the dispensing station 42 is where the first step in the measurement operation is performed.

The remaining stations, that is, an introducing station 44; a detecting station 46; cleansing stations 47; and a microchip attaching/removing station 56, for attaching and removing the microchips 100, are provided on the rotating table 40 in this order in the counterclockwise direction. Note that in the present embodiment, the cleansing stations 47 include four stations, that is, a chemical cleansing station 48, water cleansing stations 50 and 52, and a residual liquid suctioning station 54. The four cleansing stations 48, 50, 52, and 54 perform a chemical cleansing step, a first water cleansing step, a second water cleansing step, and a residual liquid suctioning step, respectively. Note that the element denoted by reference numeral 13 in FIG. 8 (User Interface Section) is a so-called operating panel.

Cover members 44b, 46b, and 52b are mounted on the casing 2 such that they are capable of approaching and separating from the rotating table 40, to perform opening and closing operations. Accordingly, only the rotating table 40 rotates, and the cover members 44b, 46b, and 52b do not move within a plane parallel to the rotating table 40.

Next, each of the stations 42, 44, 46, 47 (48, 50, 52, 54), and 56 will be described further, with reference to FIG. 7 and FIG. 8.

The eight stations are provided about the circumference of the rotating table 40 such that they are equidistant from each other. Therefore, the amount of time spent performing operations at each of the eight stations 42 through 56 is the same, for example, 200 seconds. That is, after 200 seconds pass, the rotating table 40 rotates to the next step. Accordingly, one cycle is completed after a single rotation of 200×8=1600 seconds, and measurement operations for a first microchip 100 are completed. Thereafter, the measurement operations for the remaining microchips 100 are sequentially completed after 200 second intervals.

When a microchip 100 is placed at a position corresponding to the dispensing station 42, the moving body 12a of the dispensing mechanism 12 moves above the microchip 100, and samples and the like are dripped into a predetermined well 106 by the probe 12b. This operation is repeated for all of the wells 106 into which reagents or samples are to be dripped (first step).

A cover member 44b is provided at the introducing station 44 so as to be openable and closable. Tubes 44c for communicating with predetermined wells 106 of the microchip 100 when the microchip 100 is placed at the introducing station 44 are mounted on the cover member 44b. Pressurized gas is supplied into the wells C and D illustrated in FIG. 2 via the tubes 44c (second step).

A cover member 46b is also mounted on the detecting station 46. Electrodes (not shown) for applying voltages used in electrophoresis are provided on the underside of the cover member 46b. The electrodes are positioned to correspond to the wells A, F, and G, through which the voltages are applied.

A light measuring section 58 of the detecting station 46 has the aforementioned detecting device 6 (refer to FIG. 2) incorporated therein. Electrophoretic voltages are applied to the electrodes at the detecting station 46, to cause electrophoresis of the sample (third step). During electrophoresis, the sample is maintained in a low temperature state, for example, in a state in which the temperature of the sample fluid is 10° C., depending on the sample.

The wells 106 to which voltages are applied to are switched (fourth step). Electrophoreses is continued in a state in which the temperature of the sample fluid is maintained at 10° C., and measurement of the measurement target substance is performed (fifth step).

Next, the cleansing stations 47 that employ the micro-flow channel cleansing method of the present invention will be described in detail.

The cleansing stations 47 include the four stations 48, 50, 52, and 54, each of which performs a single cleansing step. The chemical cleansing station 48 employs a chemical (cleansing agent) such as NaOH (sodium hydroxide) to cleanse the flow channels 110 of used microchips 100. The chemical cleansing station 48 is configured to cleanse wells 106 contaminated by samples, by discharging the chemical into the wells 106 and then suctioning it out. At this time, the chemical is suctioned from the flow channels 110 at a negative pressure of for example, 300 g/cm².

FIG. 9 is a magnified perspective view that illustrates the main parts of the chemical cleansing station 48. Cleansing of the micro-flow channels is performed by the micro-flow channel cleansing method of the present invention at the chemical cleansing station.

Probes 48p and 48q are configured to inject and suction chemicals into and from each of the flow channels 110 within the flow channel substrate 102 of the microchip 100. The probes 48p and 48q are capable of moving in the directions indicated by arrow 60. This movement is performed employing a motor 48c illustrated in FIG. 4, and a threaded shaft 48d, which is driven by the motor 48c (refer to FIG. 7). That is, a member 48e that supports the microchip 100 is engaged with the threaded shaft 48d, and the microchip 100 is moved reciprocally in the radial direction of the rotating table 40 by rotation of the threaded shaft 48d.

Note that only the tips of the probes 48p and 48q are illustrated in FIG. 9. However, the probes 48p and 48q extend as illustrated by the broken lines, or have tubes attached thereto. A chemical (cleansing agent) container 15 and a probe cleansing tank 17 are also provided in the chemical cleansing station 48. The cleansing agent is contained in the chemical container 15. The cleansing agent is supplied to the wells 106 by the probes 48p and 48q. During the chemical cleansing operation, the tips of the probes 48p and 48q are inserted into the wells 106, and therefore the tips of the probes 48p and 48q are cleansed within the probe cleansing tank 17 after each insertion. Openings 65a that communicate with a syringe pump (not shown) are formed in a sealing plate 65 at positions that correspond to the wells 106. Pressure supplied by the syringe pump is utilized to expel the chemical from the wells 106 and the micro-flow channels 110.

The chemical is injected into specific wells 106, and suctioned out from other wells 106 at the aforementioned negative pressure of 300 g/cm². The manner of cleansing will be described with combined reference to FIG. 10.

FIG. 10 is a magnified sectional view that illustrates the concept of cleansing of a well 106 and the application of negative pressure on another well 106. FIG. 10 illustrates a state in which the probe 48p is inserted into a well 106, while injecting and suctioning a chemical 62 such that it does not overflow from the well 106.

FIG. 10 also illustrates a state in which another well 106 is sealed by sealing members 64 and the sealing plate 65, while negative pressure is applied to perform suction.

In this manner, the samples and chemical 62 are injected into and suctioned from the wells 106 and the flow channels 110 while the probes 48p and 48q move. Thereby, the flow channels 110 are sufficiently cleansed by the micro-flow channel cleansing method of the present invention. Accordingly, the degree of cleansing is high. Note that the portion denoted by reference number 102 in FIG. 7 corresponds to the micro-flow channel substrate 102.

After the chemical cleansing step, the water cleansing station 50 performs injection and suction of water to all of the wells 106 in the same manner as described above.

The water cleansing station 50 also executes cleansing of the micro-flow channels using the micro-flow channel cleansing method of the present invention. The difference is that the cleansing fluid employed at the water cleansing station 50 is water.

Further, the water cleansing station 52 expels the chemical from the flow channels 110 with a water pressure of, for example, 10 kg/cm². At this time, the well 106 through which the water and the chemical are expelled is open to the atmosphere, and the expelled waste liquid is contained in the waste liquid container 22.

The water cleansing station 52 may also execute cleansing of the micro-flow channels using the micro-flow channel cleansing method of the present invention. The cleansing fluid employed at the water cleansing station 52 is also water.

Next, residual fluid is suctioned from the wells 106 at the residual fluid suctioning station 54. This operation is performed by a probe 54p (refer to FIG. 7), which is connected to a negative pressure source, being inserted into the wells 106′.

Next, the cleansed microchips 100 are conveyed to the microchip attaching/removing station 56. If a microchip 100 has been used a predetermined number of times, which is considered to be its usable lifetime, for example, 10 to 200 times, the microchip attaching/removing station 56 removes the microchip 100 and mounts a new microchip 100 on the rotating table 40. The microchip attaching/removing station 56 only functions when exchanging microchips 100, and does not operate during normal measurement.

FIG. 11 illustrates magnified perspective views of the manner in which the microchips 100 are exchanged at the microchip attaching/removing station 56. FIG. 11A illustrates a state in which a microchip is standing by at the attaching/removing station, and FIG. 11B illustrates a state in which a microchip is being discharged from the attaching/removing station.

An opening 56ccorresponding to a recess 56a of the rotating table 40 is provided, for example, in the casing 2, at the microchip attaching/removing station 56. The opening 56cmay be open at all times, or an appropriate lid (not shown) may be provided to open and close the opening 56c.

A microchip 100 at the end of its useful lifetime can be accessed through the opening 56cand removed, and a new microchip 100 may be loaded through the opening 56c. In order to judge whether a microchip 100 has reached the end of its useful lifetime, a wireless tag 101 (recording portion) may be provided on the microchip 100. The number of times that the microchip 100 has been used may be automatically be recorded in the wireless tag 101, and when a predetermined number is reached, a message prompting exchange of the microchip 100 may be displayed on the display panel 16. Alternatively, an operator may be notified of the need to exchange microchips 100 by an appropriate audio signal. The counting of the number of uses and recording of the number of uses into the wireless tag 101 may be managed by a control section 11 (refer to FIG. 8), provided on the rear side of the apparatus 1, for example. Note that the wireless tag 101 may be provided at a desired position on the microchip 100 by fitting, embedding, or any other means.

Note that in the present embodiment, the microchips 100 are rotated through the stations. Alternatively, the stations may be rotated to perform their respective processes on the microchips 100. In addition, the cleansing stations 47 include the plurality of cleansing stations that perform different cleansing steps. Alternatively, the plurality of cleansing steps may be performed by a single cleansing station. Further, in the above embodiment, the reagents and samples are introduced into the wells by being pressurized. Alternatively, the reagents and samples may be introduced into the wells by suctioning from an opposing well. The pressurization and suction may be performed independently, or simultaneously.

1-5. (canceled)

6. A micro-flow channel cleansing method for cleansing wall surfaces of micro-flow channels having at least one branching channel, by causing cleansing fluid to flow therethrough, characterized by:
the cleansing fluid being caused to flow through the at least one branching channel such that there is no residual fluid on the wall surfaces thereof.

7. A micro-flow channel cleansing method as defined in claim 6, characterized by:
the flow direction of the cleansing fluid with respect to the at least one branching channel being changed, by performing injection and suction of the cleansing fluid into and out of a single micro-flow channel that communicates with the at least one branching channel.

8. A micro-flow channel cleansing method as defined in claim 6, characterized by:
the flow direction of the cleansing fluid with respect to the at least one branching channel being changed, by performing injection and suction of the cleansing fluid into and out of micro-flow channels that have the at least one branching channel therebetween and communicate therewith, at least once.

9. A micro-flow channel cleansing method as defined in claim 7, characterized by:
the flow direction of the cleansing fluid with respect to the at least one branching channel being changed, by performing injection and suction of the cleansing fluid into and out of micro-flow channels that have the at least one branching channel therebetween and communicate therewith, at least once.

10. A micro-flow channel cleansing method as defined in claim 6, characterized by:
the at least one branching channel branching in a T-shape.

11. A micro-flow channel cleansing method as defined in claim 7, characterized by:
the at least one branching channel branching in a T-shape.

12. A micro-flow channel cleansing method as defined in claim 8, characterized by:
the at least one branching channel branching in a T-shape.

13. A micro-flow channel cleansing method as defined in claim 9, characterized by:
the at least one branching channel branching in a T-shape.

14. A micro-flow channel cleansing method as defined in claim 6, characterized by:
the micro-flow channels being formed in a microchip to be utilized by a clinical analysis apparatus, and being for reagents and samples to be introduced thereinto.

15. A micro-flow channel cleansing method as defined in claim 7, characterized by:
the micro-flow channels being formed in a microchip to be utilized by a clinical analysis apparatus, and being for reagents and samples to be introduced thereinto.

16. A micro-flow channel cleansing method as defined in claim 8, characterized by:
the micro-flow channels being formed in a microchip to be utilized by a clinical analysis apparatus, and being for reagents and samples to be introduced thereinto.

17. A micro-flow channel cleansing method as defined in claim 9, characterized by:
the micro-flow channels being formed in a microchip to be utilized by a clinical analysis apparatus, and being for reagents and samples to be introduced thereinto.

18. A micro-flow channel cleansing method as defined in claim 10, characterized by:
the micro-flow channels being formed in a microchip to be utilized by a clinical analysis apparatus, and being for reagents and samples to be introduced thereinto.

19. A micro-flow channel cleansing method as defined in claim 11, characterized by:
the micro-flow channels being formed in a microchip to be utilized by a clinical analysis apparatus, and being for reagents and samples to be introduced thereinto.

20. A micro-flow channel cleansing method as defined in claim 12, characterized by:
the micro-flow channels being formed in a microchip to be utilized by a clinical analysis apparatus, and being for reagents and samples to be introduced thereinto.

21. A micro-flow channel cleansing method as defined in claim 13, characterized by:
the micro-flow channels being formed in a microchip to be utilized by a clinical analysis apparatus, and being for reagents and samples to be introduced thereinto.
